(19) United States
(12) Patent Application Publication
(10) Pub. No.: US 2002/0131012 A1
(43) Pub. Date: Sep. 19, 2002

(54) Assembly of eyeglasses and auxiliary glasses

(76) Inventor: Jui-Shan Tsai, Taichung (TW)

Correspondence Address: Liberty Patent & Trademark Office, 3F-7, No. 66, Sec. 3, Pei-Ping Rd., Taichung, 406, TW

(21) Appl. No.: 09/809,614

(22) Filed: Mar. 16, 2001

(51) Int. Cl. G02C 7/08; G02C 9/00

(52) U.S. Cl. 351/57; 351/47

(57) ABSTRACT

The invention relates to an assembly of eyeglasses with auxiliary glasses, wherein the eyeglasses have a crossbar connecting two lenses, on two sides of the lenses are two elbows welded to two leg rods, while the auxiliary glasses have a connecting crossbar joining two lenses. On the elbows of the eyeglasses and on the crossbar are respectively fitted with magnetic members. On the auxiliary glasses are also fitted with matching magnetic members. On the connecting crossbar is a hook part. Thereby, the magnetic members are used to attract the auxiliary glasses and the eyeglasses and join them together. On the connecting crossbar of the auxiliary glasses is a hook part that can be hooked onto the crossbar of the frameless eyeglasses, so they can be firmly joined.

### BACKGROUND OF THE INVENTION

Conventionally, eyeglasses are joined to auxiliary glasses by way of clasps, which involve inconvenient operation, and the auxiliary glasses would fall of easily, so they have been replaced by magnetic devices. In regular types of magnetic eyeglasses and auxiliary glasses, matching magnetic members are attached respectively to the auxiliary glasses and the eyeglasses for joining purposes. For example, an elbow is fitted respectively to two sides of the frames of the eyeglasses, with a magnetic member fitted to the front side of each elbow. Then, at two ends of the auxiliary glasses are extension rods, and on the front of the extension rods are magnetic members. The magnetic members provide attraction to join the eyeglasses and the auxiliary glasses.

As described above, though conventional magnetic types have advantages, such as simplified and firm construction, over traditional clasping types in their operation and positioning performance, the joining strength provided by magnetism and the small areas of magnetic members is not sufficient to withstand possible impact from travel or user's body movement. In that case, the auxiliary glasses could easily fall off, causing inconvenience to the user. Therefore, further design to increase its joining strength is needed, in addition to the magnetism of the magnetic members. Besides, the significant length of the auxiliary glasses makes it difficult for the user to store or carry the glasses around. Therefore, improvement is needed for the aforementioned assembly of eyeglasses and auxiliary glasses.

### BRIEF DESCRIPTION OF THE INVENTION

For that purpose, the inventor has provided an assembly of eyeglasses and auxiliary glasses, comprising magnetic members on the eyeglasses and the auxiliary glasses, as well as a connecting crossbar equipped with a hook on the frameless auxiliary eyeglasses, so that while the auxiliary glasses can be magnetically attracted to, and the connecting crossbar of the auxiliary glasses can be mechanically engaged onto the eyeglasses, to enable firmer connection between the two units.

Moreover, the connecting crossbar of the auxiliary glasses can be designed to have hinge members or a hinge mechanism, so that when not in use, the auxiliary glasses can be folded to reduce its integral measurements.

### BRIEF DESCRIPTION OF DRAWINGS

The main features of this invention can be better understood from the following drawings of preferred embodiment, which are explained in details as follows.

FIG. 1 is a perspective view the invention.

FIG. 1-A is a schematic view of part of the invention.

FIG. 2 is an assembled view of the invention.

FIG. 3 is a structural view of the assembly of the invention.

FIG. 4 is a schematic view of the invention with magnetic attraction at the front.

FIG. 5 is a perspective view of the invention with magnetic attraction at the front.

FIG. 6 is a view of the auxiliary glasses when folded.

FIG. 7 is a schematic view of the invention with lower magnetic attraction.

FIG. 8 is a section view of the invention with lower magnetic attraction.

FIG. 9 is a schematic view of the invention with upper magnetic attraction.

FIG. 10 is a section view of the invention with upper magnetic attraction.

FIG. 11 is a schematic view of the invention with side magnetic attraction.

FIG. 12 is another schematic view of the invention with side magnetic attraction.

FIG. 13 is a schematic view of the invention with front magnetic attraction and side hook connection.

FIG. 14 is a structural view of the invention with front magnetic attraction and side hook connection.

### DETAILED DESCRIPTION OF THE INVENTION

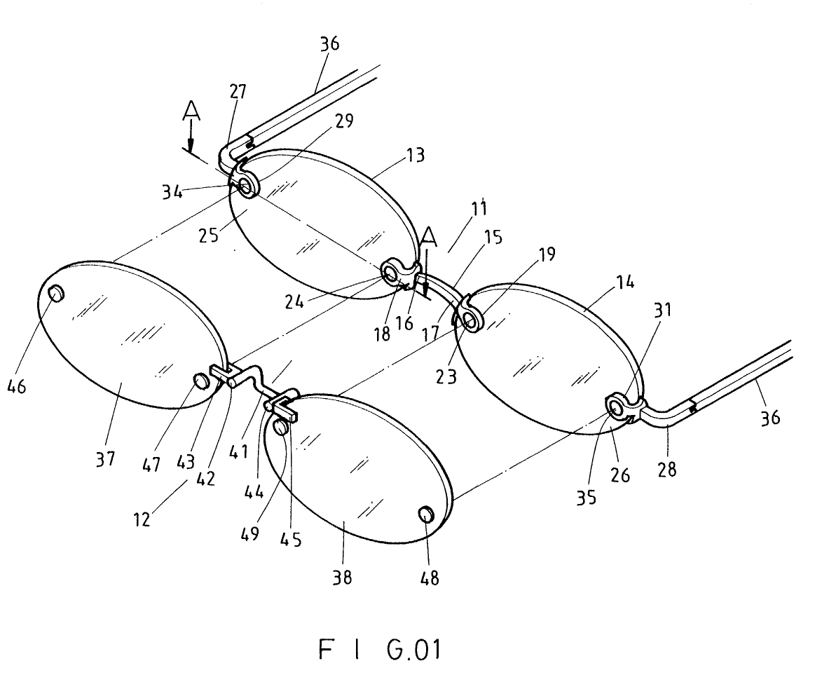

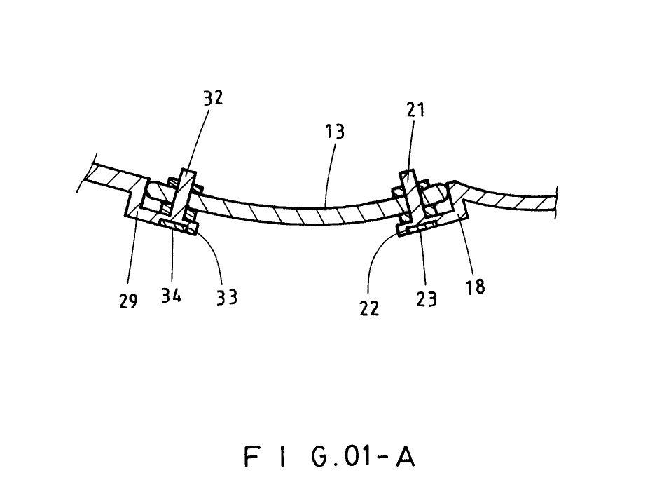

This invention is an assembled mechanism, or more specific, the assembly of eyeglasses and auxiliary glasses. As shown in FIGS. 1, 2 and 3, it comprises a pair of eyeglasses 11 and a pair of auxiliary glasses 12, with the auxiliary glasses 12 joined to the front side of the eyeglasses 11.

The eyeglasses 11 are composed of two separate lenses 13, 14, with a crossbar 15 between the two lenses 13, 14. The crossbar 15 has a first end 16 and a second end 17, formed to which are respectively a first joining piece 18 and a second joining piece 19. The joining piece 18 rests on the surface of the lens 13, and the joining piece 19 rests on the surface of the lens 14. With a locking member 21 inserted and tightened to the joining pieces 18, 19 and the lenses 13, 14, the crossbar 15 and the lenses 13, 14 can be joined together as one unit.

As shown in FIG. 1 and FIG. 1A, the locking member 21 is inserted deep inside the joining piece 18 for the tightening purpose, forming a hole 22 on the joining piece 18, the hole 22 can be inserted by a magnetic member 23. The other joining piece 19 is assembled to the lens 14 in the same way as the above procedure, there being another magnetic member 24 fastened to the joining piece 19. At the outer end 25 of the lens 13 is an elbow 27, at the outer end 26 of the lens 14 is another elbow 28. At one end of the elbow 27, 28 is respectively a joining piece 29, 31, the joining piece 29 being joined to the lens 13, the joining piece 31 to the lens 14. As shown in FIG. 1A, the joining piece 29 is fastened to the lens 13 by means of the locking member 32, the locking member 32 reaching deep into the joining piece 29, so there is the formation of a hole 33 on the joining piece 29, the hole 33 serving to position the magnetic member 34 in place. In the same way as described above, the other joining piece 31 is assembled onto the lens 14, with a magnetic member 35 on the joining piece 31. To the other end of the elbow 27, 28 is joined a foldable leg rod 36, the other end of the leg rod 36 formed as a hanging device to hang the eyeglasses 11 onto the user's ear.

Furthermore, the auxiliary glasses 12 have a connecting crossbar 39 between two lenses 37, 38. At the middle of the connecting crossbar 39 is a hook part 41 that has a backward extension serving as a catch. The connecting crossbar 39 has a first end 42 that is fastened by a clasp 43 to the lens 37, and a second end that is fastened by a clasp 45 to the lens 38. At the two ends of the lens 37 are a first magnetic member 46 and a second magnetic member 47. At the two ends of another lens 38 are also a first magnetic member 48 and a second magnetic member 49.

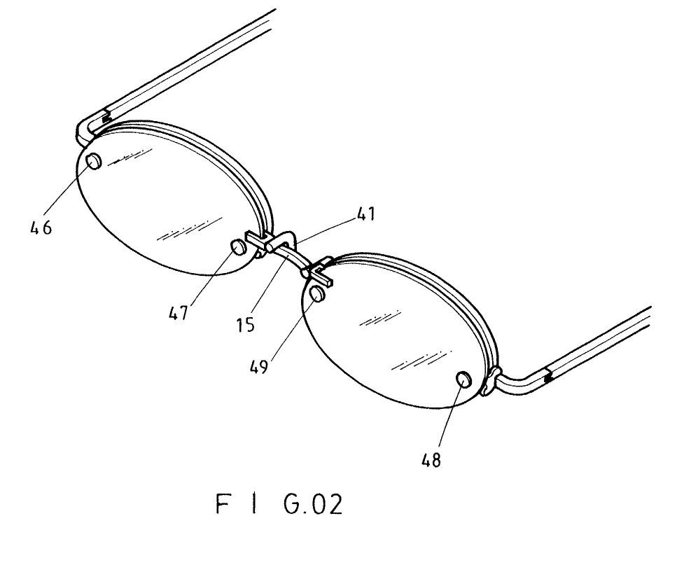

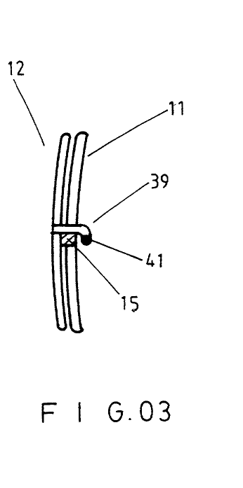

On the surface of the eyeglasses 11 are magnetic members 23, 24, 34, 35, while on the surface of the auxiliary glasses 12 are corresponding magnetic members 46, 47, 48, 49. As shown in FIGS. 2 and 3, the auxiliary glasses 12 are resting on the eyeglasses 11. The auxiliary glasses 12 are attached to the eyeglasses 11 by mutual magnetic attraction. The connecting crossbar 39 of the auxiliary glasses 12 cross beyond the crossbar of the eyeglasses 11 and the hook part 41 is engaged to the crossbar 32. Therefore, the auxiliary glasses 12 and the eyeglasses 11 are fastened steadily by magnetic attraction and the engagement of the hook part 41.

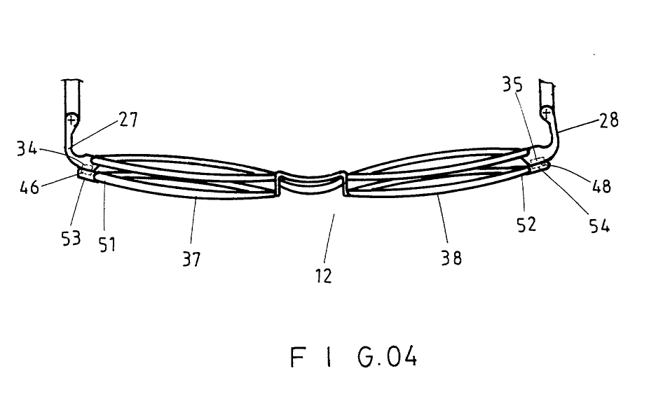

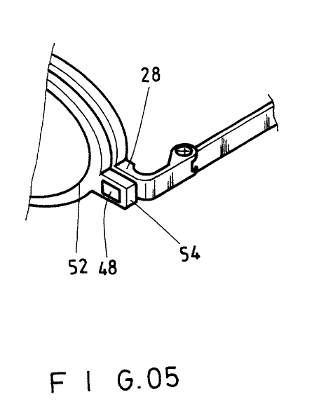

As shown in FIGS. 4 and 5, at the first end 51 of the lens 37, 38 of the auxiliary glasses 12 is a first extension rod 53, and at the first end 52 of the lens 38 is a second extension rod 54. On the extension rod 53, 54 are respectively a magnetic member 46, 48. On the elbow 27, 28 are respectively a magnetic member 34, 35. Thus, when the auxiliary glasses 12 and the eyeglasses 11 are aligned to each other, there will be a magnetic force attracting each other to join the auxiliary glasses 12 and the eyeglasses 11 as one unit.

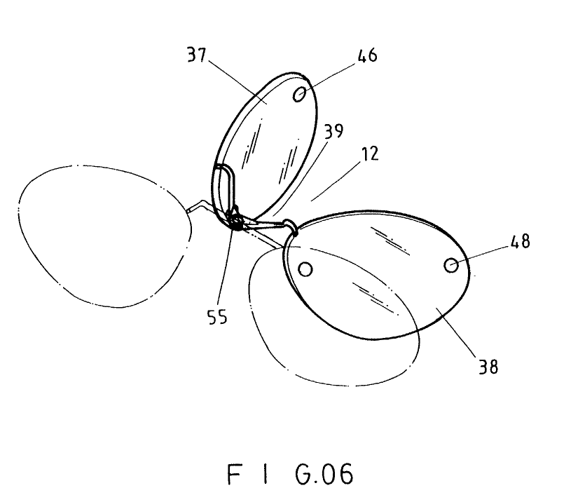

As shown in FIG. 6, on the connecting crossbar 39 of the auxiliary glasses 12 is a hinge member 55, or a hinge connector, so the two lenses 37, 38 of the auxiliary glasses 12 can be folded in half on the hinge member 55, when the magnetic members 46, 48 on the lenses 37, 38 will be attracted to each other to provide better positioning of the folded auxiliary glasses 12.

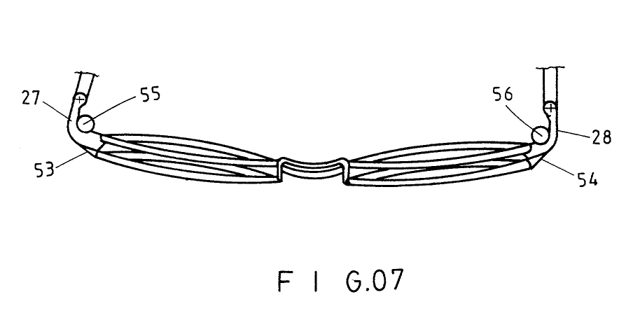

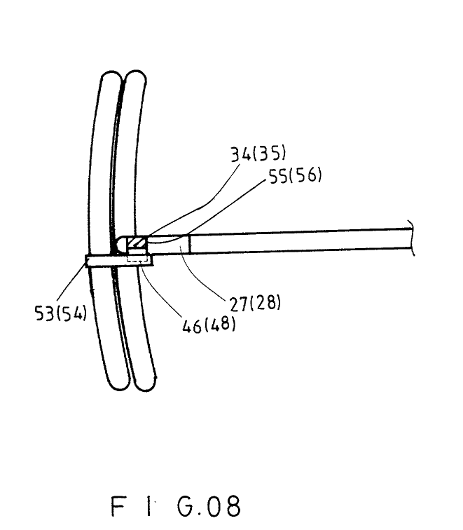

The assembly of the auxiliary glasses 12 with the eyeglasses 11 can involve the following variation. As shown in FIGS. 7 and 8, the ends of the first extension rod 53 and the second extension rod 54 are extended to the back, having magnetic members 46,48 that are protruded upwards. On the elbows 27, 28 are sleeves 55, 56, inside the sleeves 55, 56 are magnetic members 34, 35. The magnetic members 34, 35 are spaced from the bottom of the sleeves 55, 56 at a distance. Thus, when the auxiliary glasses 12 are assembled to the eyeglasses 11, the first extension rod 53 and the second extension rod 54 are located below the elbows 27, 28, so the protrusions of the magnetic members 46, 48 reach into the sleeves 55, 56, and mutually attracted with the magnetic members 34, 35 inside the sleeves 55, 56.

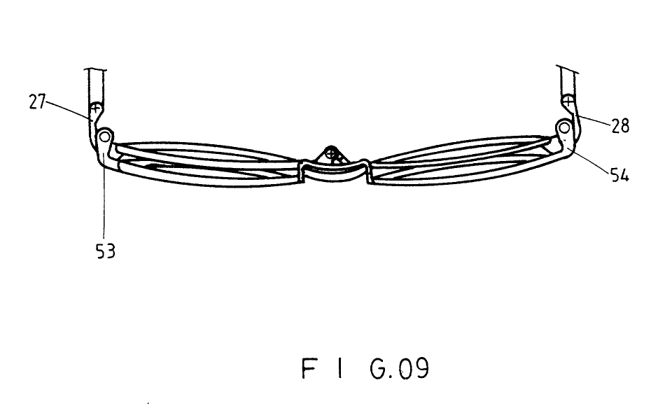

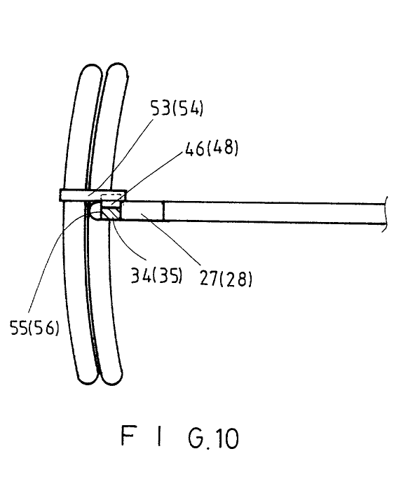

As shown in FIGS. 9 and 10, the ends of the first extension rod 53 and the second extension rod 54 are extended to the back, at the ends are magnetic members 46, 48 that protrude downwards. On the elbows 27, 28 are sleeves 55, 56. Inside the sleeves 55, 56 are magnetic members 34, 35. The magnetic members 34, 35 are spaced at a distance from the top of the sleeves 55, 56. So, when the auxiliary glasses 12 are assembled with the eyeglasses, the first extension rod 53 and the second extension rod 54 are located at the top of the elbows 27, 28, so the protrusions of the magnetic members 46, 48 can reach into the sleeves 55, 56, to be attracted mutually to the magnetic members 34, 35 inside the sleeves 55, 56.

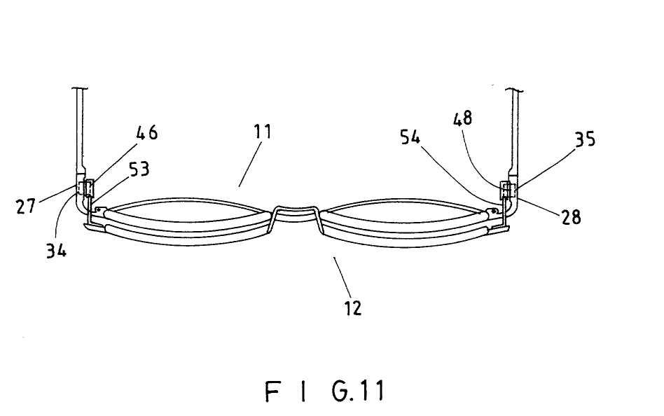

As shown in FIG. 11, which illustrates the assembly of another pair of auxiliary glasses 12 and eyeglasses 11. The ends of the first extension rod 53 and the second extension rod 54 are extended to the back. There are magnetic members 34, 35 on the inside of the elbows 27, 28. So, when the auxiliary glasses 12 and the eyeglasses 11 are assembled, the first extension rod 53 and the second extension rod 54 are located at the inside of the elbows 27, 28, so the magnetic members 46, 48 are attracted mutually to the magnetic members 34, 35.

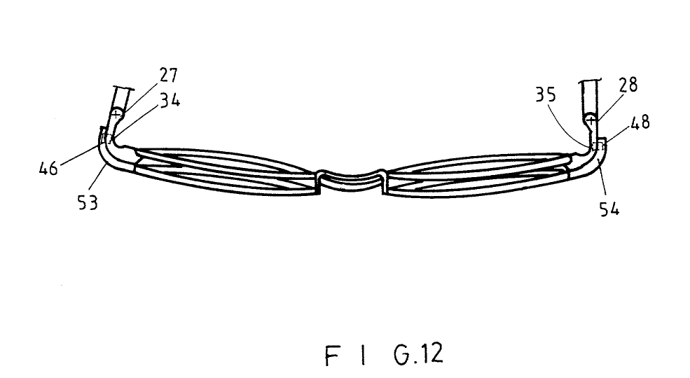

As shown in FIG. 12, which illustrates another assembly of the auxiliary glasses 12 and eyeglasses 11. Wherein, the ends of the first extension rod 53 and the second extension rod are extended to the back, with magnetic members 46, 48 on the sides of their ends. On the outside of the elbows 27, 28 are magnetic members 34, 35. So, when the auxiliary glasses 12 and the eyeglasses are assembled, the first extension rod 53 and the second extension rod 54 are located at the outside of the elbows 27, 28. so the magnetic members 46, 48 are attracted mutually to the magnetic members 34, 35.

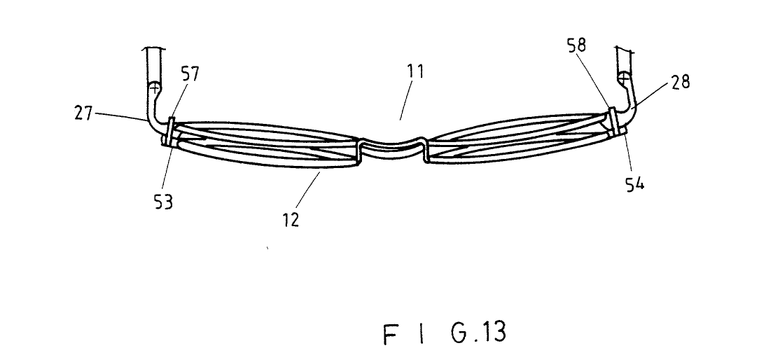

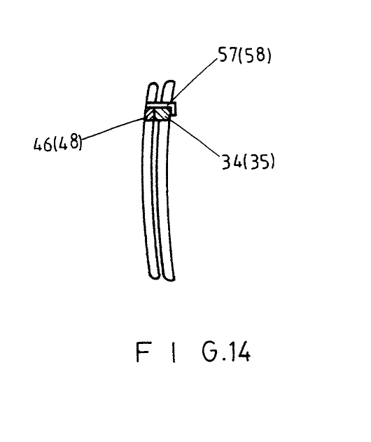

As shown in FIGS. 13 and 14, which illustrate the assembly of the auxiliary glasses 12 and the eyeglasses 11. Wherein, on the first extension rod 53 and the second extension rod 54 are respectively hook rods 57, 58 that extend to the back. On the surface of the first extension rod 53 and the second extension rod 54 are magnetic members 34, 35. So, when the auxiliary glasses 12 and the eyeglasses 11 are assembled, the first extension rod 53 and the second extension rod 54 are aligned to the elbows 27, 28, so the magnetic members 46, 48 are aligned to the magnetic members 34, 35, and mutual attraction is created, and the hook rods 57, 58 will be hooked to the elbows 27, 28, and sucked into position with the magnetic members 34, 35.

To conclude, with the mutual magnetic attraction and positioning between the auxiliary glasses and the eyeglasses, this invention has satisfied the requirements for a patent right. Furthermore, this invention has never been disclosed in any publications nor has it been applied in public before this date. This application for a patent right is filed accordingly Your favorable consideration will be appreciated.

What is claimed is:

1. An assembly of eyeglasses and auxiliary glasses, comprising the following:
A pair of eyeglasses, fitted with a crossbar between two lenses, at two sides of the lenses being elbows for connection to two leg rods, there being at least one magnetic member on the eyeglasses;
A pair of auxiliary glasses, with a connecting crossbar between two lenses, so the two lenses can be joined as one unit, there being magnetic members on the auxiliary glasses to match the magnetic members on the eyeglasses, on the connecting crossbar being a bent hook part for fastening and positioning purposes; Such auxiliary glasses and eyeglasses use their magnetic members to attract each other, while the hook part of the auxiliary glasses engages the crossbar of the eyeglasses, the two units can be securely positioned.

2. The assembly of eyeglasses and auxiliary glasses as claimed in claim 1, wherein at the ends of the crossbar of the eyeglasses are joining pieces that can be joined to the lenses, with a magnetic member fitted to each joining piece.

3. The assembly of eyeglasses and auxiliary glasses as claimed in claim 1, wherein at the ends of the elbows of the eyeglasses are joining pieces that can be joined to the lenses, with magnetic members fitted to the joining pieces.

4. The assembly of eyeglasses and auxiliary glasses as claimed in claim 1, wherein there are magnetic members on the lenses of the auxiliary glasses to match the magnetic members on the frameless eyeglasses.

5. The assembly of eyeglasses and auxiliary glasses as claimed in claim 1, wherein on the connecting crossbar of the auxiliary glasses are hinge members to fold the two lenses of the auxiliary glasses.

6. The assembly of eyeglasses and auxiliary glasses as claimed in claim 1, wherein extending from the outer ends of the lenses of the auxiliary glasses are extension rods, on the extension rods are magnetic members, and matching the magnetic members on the auxiliary glasses are other magnetic members on the elbows of the eyeglasses, which provide magnetic attraction to join the auxiliary glasses and the eyeglasses.

7. The assembly of eyeglasses and auxiliary glasses as claimed in claim 1, wherein at the outer ends of the two lenses of the auxiliary glasses are extension rods, the ends of the extension rods extending to the back, the magnetic members at the ends protruding upwards, meanwhile, on the elbows are sleeves, inside the sleeves are magnetic members, the magnetic members spaced at a specified distance from the bottom of the sleeves, so that when the auxiliary glasses and the eyeglasses are assembled, the extension rods are aligned to the lower parts of the elbows, so the protrusions of the magnetic members can reach inside the sleeves and form mutual attraction with the magnetic members inside the sleeves.

8. The assembly of eyeglasses and auxiliary glasses as claimed in claim 1, wherein at the outer ends of the two lenses of the auxiliary glasses are extension rods, the ends of the extension rods extending to the back, and at the ends are magnetic members that protrude downward, meanwhile on the elbows are sleeves, inside the sleeves are magnetic members, the magnetic members spaced at a specified distance from the top of the sleeves, so that when the auxiliary glasses and the eyeglasses are assembled, the extension rods are aligned to the upper part of the elbows, so the protrusions of the magnetic members can reach into the sleeves to form mutual attraction with the magnetic members inside the sleeves.

9. The assembly of eyeglasses and auxiliary glasses as claimed in claim 1, wherein at the outer ends of two lenses of the auxiliary glasses are extension rods, the ends of the extension rods extending to the back, and on the sides of the ends are magnetic members, on the sides of the elbows are also magnetic members, so that when the auxiliary members and the eyeglasses are assembled, the extension rods are aligned to one side of the elbows, providing mutual attraction and positioning function for the magnetic members.

10. The assembly of eyeglasses and auxiliary glasses as claimed in claim 1, wherein at the outer ends of the two lenses of the auxiliary glasses are extension rods, on the extension rods are respectively a hook rod that extends to the back, on the surfaces of the extension rods are magnetic members, on the elbows of the eyeglasses are matching magnetic members, so that when the auxiliary glasses and the eyeglasses are assembled, the extension rods are aligned to the elbows to form attraction to the magnetic members, while the hook rods can be hooked on the elbows to form attraction to the magnetic members on the elbows.
